(19) United States
(12) Patent Application Publication
(10) Pub. No.: US 2004/0053802 A1
(43) Pub. Date: Mar. 18, 2004

(54) Use of transition metal complexes with nitrogen-containing polydentate ligands as a bleaching catalyst and bleaching agent composition

(75) Inventors: Ulrike Kunz, Gelnhausen (DE); Harald Jakob, Hasselroth (DE); Michael del Grosso, Freigericht (DE); Astrid Dorfer, Grundau (DE)

Correspondence Address: FITCH, EVEN, TABIN & FLANNERY, Suite 401L, 1801 K Street, NW, Washington, DC, 20006-1201, US

(73) Assignee: Degussa AG

(21) Appl. No.: 10/464,855

(22) Filed: Jun. 19, 2003

(30) Foreign Application Priority Data
Jun. 21, 2002 (DE) 102 27 774.5

(51) Int. Cl. C11D 7/18

(52) U.S. Cl. 510/311

(57) ABSTRACT

The present invention is directed to transition metal complexes that can be used as bleaching catalysts for peroxy compounds. The complexes contain a ligand of the general formula

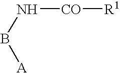

wherein B is a bridge member, such as o-phenylene or pyridine-2,6-diyl, and A represents the group —NH—CO—R¹ or

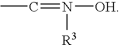

### CROSS REFERENCE TO RELATED APPLICATIONS

This application claims priority to German Application No. 102 27 774.5, filed Jun. 21, 2002, which is incorporated in its entirety herein by reference.

### Field of the Invention

The present invention relates to the use of transition metal complexes with nitrogen-containing polydentate ligands as bleaching catalysts and to bleaching agent compositions comprising such catalysts. The activity of peroxy compounds in washing, bleaching and cleaning processes at low temperature is increased by the transition metal complexes.

### BACKGROUND OF THE INVENTION

Inorganic peroxy compounds (particularly hydrogen peroxide and compounds which liberate hydrogen peroxide, such as sodium perborate monohydrate, sodium perborate tetrahydrate and sodium percarbonate) have been employed for a long time as oxidizing agents in bleaching, washing and cleaning processes. Typically, sufficiently rapid bleaching of soiled textiles requires a temperature of at least 80° C. However, the oxidizing action of inorganic peroxygen compounds at reduced temperature can be improved using bleaching activators. These activators are, in particular, N- and O-acyl compounds, for example polyacylated alkylenediamines (such as tetraacetylethylenediamine (TAED)), acetylated glycolurils, N-acetylated hydantoins, diketopiperazines, carboxylic acid anhydrides, carboxylic acid esters (such as, in particular, sodium nonanoyloxy-benzenesulfonate (NOBS)), and acylated sugar derivatives.

Using a combination of a peroxy compound and an activator, bleaching can be carried out at about 60° C. instead of above 80° C. without a loss in activity. In efforts to carry out washing and bleaching below 60° C., the use of transition metal complexes (in particular complexes of manganese, iron, cobalt and copper), with at least one polydentate organic ligand (in particular nitrogen-containing ligands), has been described in many documents. Reference is made by way of example to the complexes described in: EP 0 544 490, WO 98/54282, WO 00/12808, WO 00/60043, WO 00/52124, EP 0 392 592, WO 99/64156 and WO 00/12667.

Unfortunately, attempts to use transition metal complexes below 60° C. have been only partially successful. If reactivity is too high, there is the risk of a change in the colour of dyed textiles and, in the extreme, of oxidative damage to the fibres. Furthermore, some complexes decompose the peroxygen compound without a bleaching action, are insufficiently stable to hydrolysis, or are susceptible to oxidation.

WO 00/32731 teaches that bleaching catalysts with di(2-pyridyl) methylamine organic nitrogen-containing ligand are suitable for increasing the oxidizing and bleaching action of hydrogen peroxide. A further increase is achieved by combining the bleaching catalyst with a so-called activator which can form a peroxycarboxylic acid in the presence of a source of hydrogen peroxide.

International application WO 98/03263 discloses homogeneous oxidation catalysts which are transition metal complexes with a macrocyclic ligand. The ligand includes four donor atoms, such as nitrogen, usually in the form of amides, so that the ligand is a tetraamide. Similar macrocyclic ligands and chelate complexes are taught in WO 99/64156, where the ligand can contain four amidic or two aminic and two amidic nitrogen atoms. Such ligands are indeed stable to oxidation, but their activity as bleaching catalysts is not as high as may be desired.

Overall, it has been found that a variety of different properties are required in washing, bleaching and cleaning compositions and the products that are presently available do not fully meet the diverse needs of the trade.

### SUMMARY OF THE INVENTION

The present invention provides for the use of a transition metal complex with at least one nitrogen-containing polydentate ligand as a bleaching catalyst for activation of a peroxy compound or of oxygen, wherein the complex is mono- or polynuclear, the transition metal (M) is manganese, iron, cobalt or copper and the nitrogen-containing polydentate ligand (L), at least one of which is present, has the general formula (I)

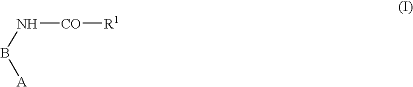

wherein A represents either the group —NH—CO—R² or the group

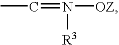

the bridge member B is chosen from the group consisting of

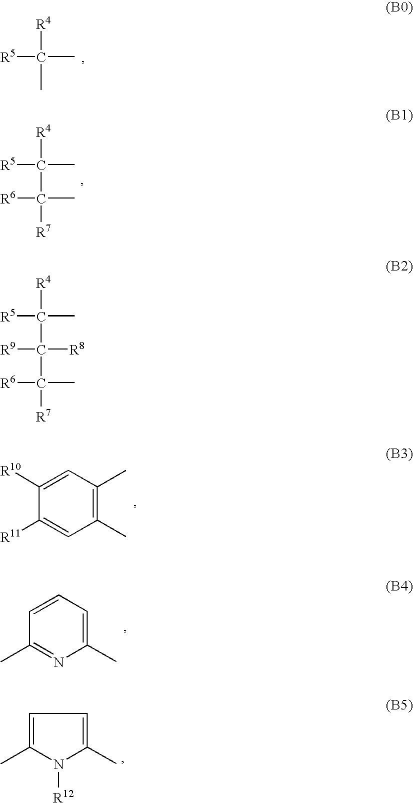

wherein R⁴ to R⁷ independently of one another represent a radical from the series consisting of H, arylalkyl, aryl, heteroaryl,

wherein R⁴ with R⁵ or/and R⁶ with R⁷ or R⁴ with R⁶ together with the atom(s) carrying them can form a five- to seven-membered, in particular five- or six-membered cycloaliphatic or O- or N-heterocyclic ring, which can also contain a double bond,

wherein the structural elements of the general formulae (B0) to (B5) have a total of 2 to 20 C atoms,

R⁸ and R⁹ independently of one another represent a radical from the group consisting of H and methyl, or together can represent carbonyl oxygen,

R¹⁰ and R¹¹ independently of one another represent a radical from the group consisting of H, (C₁-C₄)alkyl and halogen, or together can represent a fused-on aromatic ring

R¹² can represent H or methyl,

the radicals R¹ and R² independently of one another can be a radical from the group consisting of —COOH, —CONH₂, —CONHR¹¹, C(CH₃)₂OH, 2-pyridyl, 1,3-oxazolin-2-yl, and imidazol-2-yl, or R¹—R² together can represent the radical

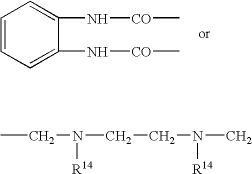

wherein R¹³ is chosen from the group consisting of linear, branched or cyclic alkyl, aryl, heteroaryl (in particular 2-pyridyl, 1,3-oxazolin-2-yl) and imidazol-2-yl and heteroalkylmethyl,

R¹⁴ is chosen from the group consisting of substituted or unsubstituted, linear, branched or cyclic alkyl, benzyl, aryl, heteroaryl and heteroarylmethyl,

R³ represents a radical from the group consisting of alkyl, aryl, heteroaryl, arylalkyl, and heteroarylalkyl,

Z represents H, alkyl, aryl, dialkylaminoethyl, or heteroaryl,

and, in the case of the oximes, R¹ additionally can represent the radical

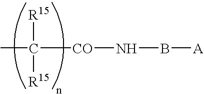

wherein n is 0 or 1, R¹⁵ is H or alkyl, and the group R¹⁵—C—R¹⁵ can be cycloalkyl.

The present invention is also directed to bleaching agent compositions which comprise a peroxy compound, in particular a source of hydrogen peroxide, and a transition metal complex in an amount effective for activation of the peroxy compound. The transition metal complex can be mono- or polynuclear and contains as the transition metal one from the series consisting of manganese in the valency level II to IV, iron in the valency level II or III, cobalt in the valency level II or III and copper in the valency level I or II. Depending on the number of heteroatoms capable of ligand formation and their steric alignment in the ligand (L), the complex can contain one or more transition metal atoms, preferably one or two metal atoms of the same type. The complex has the general formula:

[LₘMₙXₒ]Yₚ

In this formula, L denotes a ligand as described above, M denotes a transition metal atom from the above-mentioned series, X denotes a coordinating neutral, mono- or polyvalent ligand for saturation of the ligand sphere and Y denotes a non-coordinating counter-ion, which can be anionic or, if the sum of anionic ligands X and ionic substituents in the ligand L exceeds the sum of the valency of the metal atoms M, can also be cationic. The index m represents an integer in the range from 1 to 4, in particular 1 or 2, the index n represents an integer, preferably 1 or 2, the index o represents zero or an integer in the range from 1 to 8 and the index p represents zero or an integer in order to achieve a complete charge compensation. Y can also be a substituent, such as carboxylate or sulfonate, in the ligand.

The polydentate ligand L of the present invention has a structure according to the general formula (I) as already shown. According to a preferred embodiment, the complexes are cobalt complexes with the ligand B(NH—CO—R¹)₂, wherein, particularly preferably, B represents optionally substituted ortho-phenylene and/or R¹ represents a radical from the group consisting of COOH, CONHR¹, C(CH₃)₂OH where R¹ is H, (C₁-C₄)-alkyl or substituted alkyl and 2-pyridyl.

The bleaching activators of the invention can, in some cases be macrocyclic. However, ligands of preferred bleaching activators are open-chain. Substances having a simple structure, with oxamic acid or oxamide structural elements, show a surprisingly good bleaching-activating action. A new genus of active transition metal complexes contain a chelate ligand with four nitrogen donor atoms, two of which have an amide structure and two N atoms of which are the constituent of an N-heterocyclic ring. Finally, ligands with two amide groups and two oxime groups are interesting compounds for complexing with Mn, Fe, Co and Cu for the purpose of obtaining active bleaching activators.

The cyclic bridge members B can also have functional or non-functional substituents. For example they may include: OH, NH₂, COOH, SO₃H, COOMe, SO₃Me (wherein Me represents an alkali metal), N⁺(C₁-C₄-alkyl)₄, F, Cl, alkoxy (in particular (C₁-C₄)alkoxy), alkyl (in particular (C₁-C₄)alkyl), phenyl, benzyl, pyridyl, and 2-pyridylmethyl.

The radicals R¹ and R² in the ligand L can be identical or different and may be H, linear, cyclic or branched alkyl or heteroalkyl, aryl, heteroaryl, arylalkyl and heteroarylalkyl. Examples are methyl, ethyl, i-propyl, tert-butyl, benzyl, phenyl, pyridyl (in particular 2-pyridyl) 1,3-oxazolin-2-yl, 1,3-oxazolin-2-methyl and 2-pyridylmethyl.

The radical R³ in the ligand L can be aryl, heteroaryl, alkoxy, aryloxy, heteroaryl, alkyl and arylalkyl. The examples mentioned above for R¹ and R² also apply here. If R³ represents alkoxy or aryloxy, it is preferably methoxy, ethoxy, 2-hydroxyethoxy, 2-aminoethoxy, 2-N,N-di(C₁-C₄)alkylaminoethoxy or phenoxy.

Both the radicals R¹ to R³ and bridge members (B1 to B5) can have one or more functional or non-functional substituents. These substituents are the same as those discussed above in connection with the description of the bridge member B. According to particularly preferred embodiments, the heterocyclic or heteroaromatic ring systems bonded to the bridge member B contain one or more linear or branched (C₁-C₄)alkyl groups, in particular methyl, isopropyl and tert-butyl, and furthermore phenyl, benzyl, 2-pyridylmethyl or -ethyl or 4-imidazolylmethyl or -ethyl.

According to a further preferred embodiment, one or more radicals from the series consisting of R¹ to R¹⁵ or the nitrogen-containing ring systems formed therefrom contain hydrophilic substituents in order to increase the solubility of the complex. Examples of these are salt-forming functional substituents and hydroxyalkoxy groupings, which additionally can also contain one or more ether bridges.

The chemical name for some examples of suitable ligands and the formulae of some complexes containing them are as follows:

5,8,13,16-tetrahydro-5,8,13,16-tetraaza-dibenzo[a,g]cyclododecene-6,7,14,15-tetraone (TTBP)

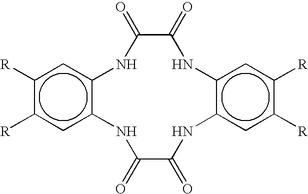

1,2-phenylene-bisoxamic acid (OPBA)

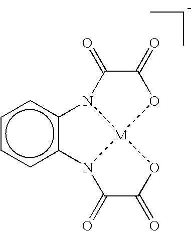

Mn complex of 1,2-phenylene-bisoxamic acid

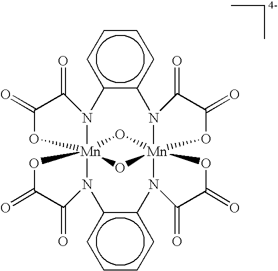

N-methyl-N′-[2-(methylaminooxalylamino)phenyl]oxalamide (PBOMA)

N-[4,5-dichloro-2-(methylaminooxalylamino)phenyl]-N′-methyloxalamide (for R=Cl)

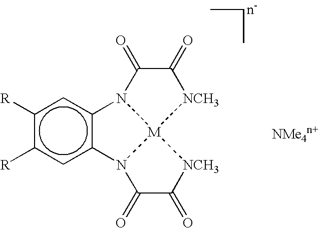

N,N′-bis(pyridine-2-carboxamido)-1,2-ethane (BPEN)

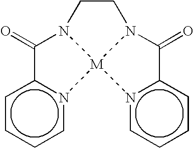

1,2-bis(pyridine-2-carboxamido)-4,5-dichlorobenzene (PCADB)

1,2-bis(4-tert-butylpyridine-2-carboxamido)-4,5-dichlorobenzene (for R=tBu)

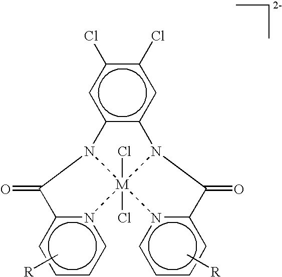

N,N′-bis[2-(1-hydroxyiminoethyl)phenyl]-dimethylmalonodiamide

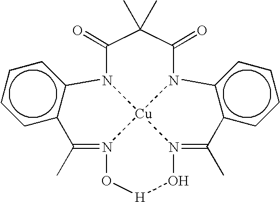

N,N′-bis[2-(2-methyl-1-oxo-1-phenyl)propyl]-dimethylmalonodiamide

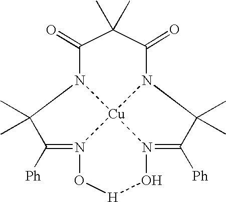

Apart from the ligand L, the catalyst can additionally contain coordinating co-ligands X, X can be a mono-, di- or trivalent anion or a neutral molecule, which can be coordinated with the transition metal in a mono-, bi- or tridentate manner. The co-ligand is preferably selected from the following groupings: OH⁻, O²⁻, NO₃⁻, PO₄³⁻, CN⁻, SCN⁻, HSO₄⁻, SO₄²⁻, Cl⁻, Br⁻, F⁻, ClO₄⁻, OCN⁻, HCO₃⁻, RS⁻, CO₃²⁻, SO₃₂—, RSO₃—, S₂O₆²—, RCO₂; H₂O, ROH, CH₃CN, NRR′R″.

The counter-ion Y of complexes can be anionic or cationic, wherein the number p is chosen such that complete charge compensation is achieved. The counter-ion is preferably selected from: F⁻, Cl⁻, Br⁻, I⁻, NO₃⁻, RSO₃⁻ (R e.g. preferably CF₃), ClO₄⁻, RCO₂⁻, PO₄⁻, HPO₄—, H₂PO₄⁻, SO₄⁻, HSO₄⁻, CO₃²⁻, HCO₃⁻, BF₄⁻, PF₆—, SO₃; Li⁺, Na⁺, K⁺, Mg²⁺, Ca²⁺, Ba²⁺.

The bleaching catalysts to be used according to the invention activate elemental oxygen and peroxy compounds. Peroxy compounds are to be understood as meaning, in particular, hydrogen peroxide, compounds which liberate hydrogen peroxide, such as, in particular, sodium perborate monohydrate, sodium perborate tetrahydrate and sodium percarbonate, perphosphates and persulfates, peroxycarboxylic acids and salts thereof and peroxycarboxylic acid bleaching precursors, so-called activators, and mixtures of such substances. Suitable peroxycarboxylic acids can be aliphatic or aromatic in nature and contain one or more peroxycarboxylic acid groups. Aliphatic peroxycarboxylic acids usually contain 1 to 20 C atoms, preferably 1 to 12 C atoms, and the particularly preferred peroxycarboxylic acid is peroxyacetic acid. Among the peroxycarboxylic acids with 2 peroxycarboxylic acid groups, those having 4 to 18 C atoms are preferred. Examples are diperoxyadipic acid, diperoxyazelaic acid, diperoxylauric acid and diperoxydodecanedioic acid, as well as salts of the acids mentioned, for example magnesium salts. Among the aromatic peroxycarboxylic acids there are, in particular, peroxybenzoic acid, m-chlorobenzoic acid, p-sulfonatoperoxybenzoic acid, diperoxyisophthalic acid, phthalimidopercaproic acid, 4,4′-sulfonyl-diperoxybenzoic acid and magnesium salts of these acids.

The peroxycarboxylic acids can also be formed in situ during use, and in particular from so-called activators, which are, in general, O-acyl compounds and N- acyl compounds. Such compounds form the corresponding peroxycarboxylic acid under perhydrolysis conditions in the presence of hydrogen peroxide or a source of hydrogen peroxide. Activators which are particularly prefered are: N,N,N′N′-tetraacetyl-ethylenediamine (TAED), Na 1-methyl-2-benzoyloxybenzene-4-sulfonate, Na nonanoyloxybenzenesulfonate (NOBS), 2-(N,N,N-trimethylammonium)ethyl-sodium 4-sulfophenylcarbonate chloride (SPCC), and pentaacetylglucose, phthalic anhydride.

For activation of peroxy compounds, the transition metal complexes according to the invention are, in general, employed in an amount of 0.0001 to 50 wt. %, and preferably at 0.01 to 20 wt. %, based on the peroxy compounds. Bleaching agent compositions according to the invention comprise at least one peroxy compound and a transition metal complex in an active amount. Such compositions should have 0.001 to 50 wt. %, in particular 0.01 to 20 wt. % and particularly preferably 0.01 to 1 wt. % of a transition metal complex with a ligand according to the invention, based on the content of peroxy compounds or their precursors.

Bleaching agent compositions according to the invention also additionally comprise one or more surfactants from the series consisting of anionic, cationic, zwitterionic and nonionic surfactants, in particular surfactants such as are used in conventional washing, bleaching and cleaning compositions. Bleaching agent compositions according to the invention can furthermore also comprise organic and/or inorganic builders, such as zeolites. Further constituents can be those such as are used in conventional washing, bleaching and cleaning compositions, including enzymes, pH regulators and conventional alkali metal carriers, such as alkali metal silicate and alkali metal carbonates.

### EXAMPLES

### Example 1

### Preparation of the dibenzotetramide 5,8,13,16-tetrahydro-5,8,13,16-tetraaza-dibenzo[a,g]cyclododecene-6,7,14,15-tetraone (TTBP)

Ligand: A solution of 5.52 g (17.9 mmol) diethyl 1,2-phenylene-dioxamate (preparation in accordance with: J. Am. Chem. Soc. 1993, 115(15):6738) and 1.94 g (17.9 mmol) 1,2-phenylenediamine in 250 ml toluene was heated under reflux for 8 hours. The product was then filtered off and dried in vacuo at 50° C. Yield: 29% (pale green solid).

M complex (M=Fe, Cu, Mn, Co): 500 mg (1.54 mmol) of ligand were dissolved in 50 ml THF under argon and the solution was then cooled to −100° C. 4.2 ml (6.17 mmol) n-butyllithium (15 percent in pentane) were added all at once by means of a disposable syringe and, after 15 minutes, 195 mg (1.54 mmol) anhydrous iron(II) chloride were added. The reaction mixture was warmed to room temperature and stirred at this temperature for 22 hours. Atmospheric oxygen was then passed through the solution in the course of 2 hours. The red-brown solid was filtered off and dried at 50° C. in vacuo. Yield: 96%

Analogously, the Mn complex was prepared with anhydrous MnCl₂ (42%, red- brown solid), the Cu complex with anhydrous CuCl₂ (70%, dark brown solid) and the Co complex with anhydrous CoCl₂ (83%, dark red solid).

### Example 2

### Preparation of N-methyl-N′-[2-(methylaminooxalylamino)-phenyl]oxalamide (PBOMA)

N,N′-1,2-Phenylene-bis(Oxamic Acid Ethyl Ester)

8.40 g (60.0 mmol) ethoxalyl chloride were added dropwise to a solution of 3.30 g (30.0 mmol) 1,2-phenylenediamine in 150 ml tetrahydrofuran analogously to the instructions in J. Am. Chem. Soc. 1993, 115(15), 6738. The solution was heated under reflux for 0.5 hour and solid constituents were then filtered off. After distillation of the solvent, a little water was added to the oily residue, with a colourless solid precipitating out. This was filtered off, washed with water and dried in vacuo. (Yield: 97%)

Reaction of the Diester With Methylamine

8.24 g (87.5 mmol) methylamine (33% in methanol) were added dropwise to a solution of 9.00 g (29.2 mmol) of the diethyl ester in 50 ml ethanol analogously to the instructions in J. Chem. Soc. Dalton Trans. 1997, 745 at room temperature and the reaction solution was then stirred vigorously for 0.5 hour at 65° C. The colourless solid was filtered off, washed with a little cold methanol and methyl tert-butyl ether and dried in vacuo. (Yield: 82%)

Co complex of PBOMA

2.62 g (7.18 mmol) cobalt(II) perchlorate dihydrate, which were dissolved in a little methanol beforehand, were added to 2.00 g (7.18 mmol) of the bisamide PBOMA and 11.0 g (30.2 mmol) tetramethylammonium hydroxide in 10 ml methanol. A pale red solid precipitated out. This was filtered off and dried. (Yield: 84%)

### Examples 3 to 8

### Catalytic Activity of Complexes

The complexes of Examples 1 and 2 and complexes prepared in an analogous manner or a manner known from the literature were investigated for their catalytic action by means of the Morin test and, in some cases, by means of a washing test.

Morin test: A sodium perborate monohydrate solution, a methanolic solution of tetraacetylethylenediamine and a dilute solution of the combination to be investigated are added to an aqueous Morin solution. After intensive mixing, the extinction/ transmission is measured at 400 nm after 30 minutes at 30° C. The blank value is measured in the absence of the combination to be investigated.

Washing test: Laboratory washing apparatus type- ATLAS LAUNDER-O-METER; Temperature: 30° C.; Washing time: 30 minutes; Water hardness: 14° d;

Staining: tea, in some cases also grass on cotton; Detergent recipe:

12.2% anionic surfactant

7.7% nonionic surfactant

2.0% soap

34.8% zeolite A

4.2% polycarboxylate

0.5% phosphonic acid

4.1% corrosion inhibitor

1.1% magnesium silicate

1.1% greying inhibitor (CMC)

2.2% sodium sulfate

4.1% sodium citrate

Bleaching Component:

17% sodium percarbonate

5% activator TAED

30 Metal complex: 2,400 ppm

Detergent concentration: 5 g/l

As a comparison, the base recipe plus percarbonate/TAED, but without a metal comples (=catalyst) was always run (CE1). This change in reflection compared with tarting fabrics is subtracted from the change in reflection achieved with rbonate/TAED/bleaching catalyst. The results are shown in Table 1:

TABLE 1

| | Complex | | | Morin test | Washing test |
|---|---|---|---|---|---|
| No. | M | L | X or Y | transmission | (Δ R) |
| 3 | Co | TTBP | | 94.8 | 0.2 |
| 4 | Co | PBOMA | Y = N(CH₃)₄⁺ | 94.8 | 1.9 |
| 5a | Co | OPBA | | 13 | 1.5 |
| 5b | Cu | OPBA | | 13.8 | n.d. |
| 5c | Fe | OPBA | | 5.8 | n.d. |
| 6 | Mn | OPBA | X = (μO)₂ | 4.2 | n.d. |
| | | | Y = (Na⁺)₄ | | |
| 7 | Mn | BPEN | | 8 | n.d. |
| 8a | Co | PCADB | X = (Cl⁻)₂ | 6.2 | n.d. |
| | | | Y = (Na⁺)₄ | | |
| 8b | Fe | PCADB | X = (Cl⁻)₂ | 46 | n.d. |
| | | | Y = (Na⁺)₄ | | |

The test results show that the catalysts according to the invention cobalt complexes, lead to a high increase in the activity of the peroxyacetic acid formed in situ from an activator (TAED) and perorate.

All references cited herein are fully incorporated by reference. Having now fully described the invention, it will be understood by one of ordinary skill in the art that the invention may be performed within a wide and equivalent range of conditions, parameters and the life, without affecting the spirit or scope of the invention or any embodiment thereof.

What is claimed is:

1. A transition metal complex which acts as a catalyst for the activation of a peroxy compound or of oxygen, comprising a transition metal (M) and at least one polydentate nitrogen-containing ligand (L), wherein said complex is mono- or polynuclear, the transition metal (M) is manganese, iron, cobalt or copper and the nitrogen-containing ligand (L) has the general formula (I): 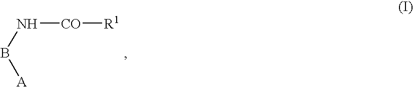
wherein A represents either the group —NH—CO—R² or the group 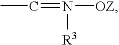
the bridge member B is selected from the group consisting of 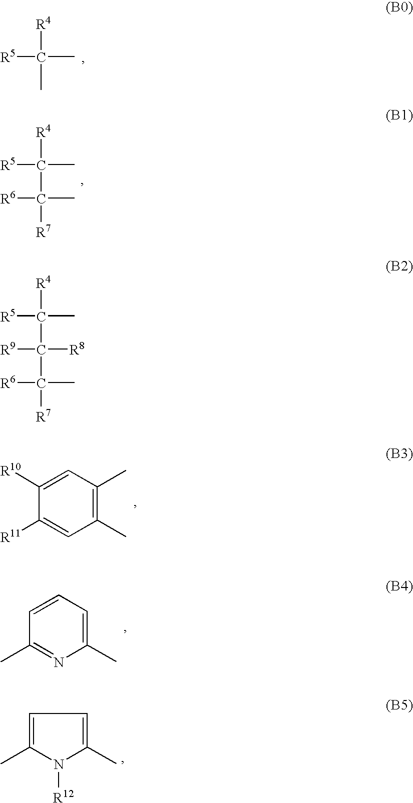
wherein R⁴ to R⁷ independently of one another represent a radical selected from the group consisting of: H, arylalkyl, aryl, heteroaryl,
wherein R⁴ with R⁵ and/or R⁶ with R⁷ or R⁴ with R⁶ together with the atom(s) to which they are attached can form a five- to seven-membered cycloaliphatic or O- or N-heterocyclic ring, which can also contain a double bond, and wherein the structural elements of the general formulae (B0) to (B5) have a total of 2 to 20 C atoms,
R⁸ and R⁹ independently of one another can be a radical from the group consisting of: H, and methyl, or together can represent carbonyl oxygen,
R¹¹⁰ and R¹¹ independently of one another can be a radical from the group consisting of: H, (C₁-C₄)alkyl, and halogen, or together can represent a fused aromatic ring,
R1 is H or methyl,
the radicals R1 and R² independently of one another can be a radical selected from the group consisting of —COOH, —CONH₂, —CONHR¹³, C(CH₃)₂OH, 2-pyridyl, 1,3-oxazolin-2-yl, imidazol-2-yl or R¹—R² together can represent the radical 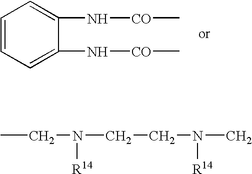
wherein R¹³ is chosen from the group consisting of: linear, branched or cyclic alkyl, aryl, heteroaryl, and heteroalkylmethyl,
R¹⁴ is chosen from the group consisting of: a substituted or unsubstituted, linear, branched or cyclic alkyl, benzyl, aryl, heteroaryl, heteroarylmethyl,
R³ is a radical from the group consisting of: alkyl, aryl, heteroaryl, arylalkyl, heteroarylalkyl and
Z represents H, alkyl, aryl, dialkylaminoethyl, or heteroaryl, and, in the case of the oximes, R¹ additionally can represent the radical 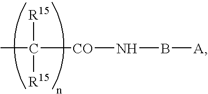
wherein n is 0 or 1, and R¹⁵ can be H or alkyl and R¹⁵—C—R¹⁵ can be cycloalkyl.

2. The transition metal complex of claim 1, wherein R¹ and R² are 2-pyridyl groups.

3. A transition metal complex which acts as a catalyst for the activation of a peroxy compound or of oxygen, comprising a transition metal (M) and at least one polydentate nitrogen-containing ligand (L), wherein said complex is mono- or polynuclear, the transition metal (M) is manganese, iron, cobalt or copper and the nitrogen-containing ligand (L), has the general formula (I′):
B(—NH—CO—R¹)₂ (I′)
wherein B represents unsubstituted or substituted ortho-phenylene, wherein the substituents can be bonded in the 4,5-position and can be Cl, F or CH₃,
R¹ is chosen from the group consisting of COOH, CO—NH—CH₃, C(CH₃)₂OH, 2-pyridyl, 1,3-oxazolin-2-yl and imidazol-2-yl or R¹ represents a radical from the group consisting of: phenylenediamine-N,N′-dicarbonyl and 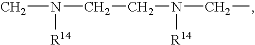
where R¹⁴ is —CH₂—COOH;
and wherein all other groups are as defined in claim 1.

4. The transition metal complex of claim 1, wherein the ligand (L) in the diamide-dioxime has the formula:
CR₂³(CO—NH—B—CR³═N—OH)₂,
wherein B represents substituted ortho-phenylene and R³ represents methyl.

5. The transition metal complex of any one of claims 1-4, wherein said complex has the general formula [LₘMₙXₒ]Yₚ, wherein:
L denotes a ligand according to any one of claims 1 to 4;
M denotes a transition metal selected from the group consisting of: Mn(II) to Mn(IV), Fe(II), Fe(III), Co(II), Co(III), Cu(I) and Cu(II),
X denotes a coordinating neutral or charged mono- or polyvalent ligand for saturation of the ligand sphere,
Y denotes a non-coordinating counter-ion which can be anionic or, if the sum of anionic substituents in the ligand L exceeds the sum of the valency of the metal atoms M, can also be cationic,
m denotes an integer in the range from 1 to 4,
n denotes the number 1 or 2,
o denotes zero or an integer in the range from 1 to 8 and
p denotes zero or an integer in the range from 1 to 8, in order to achieve complete charge compensation.

6. The transition metal complex of claim 5, wherein m is 1 or 2.

7. The transition metal complex of claim 5, wherein M is Co(II) or Co(III).

8. The transition metal complex of claim 5, wherein said complex has the general formula [LMX₀]Yₚ or [L₂M₂Xₒ]Yₚ, wherein the bridge member B of the ligand B(NH—CO—R¹)₂ denotes ortho-phenylene or 4,5-dichlorophenylene and R¹ denotes a radical from the group consisting of: COOH, CONHCH₃, C(CH₃)₂OH and 2-pyridyl.

9. A bleaching agent composition comprising a peroxy compound and the transition metal complex of any one of claims 1-4 present in an amount effective for the activation of said peroxy compound.

10. A bleaching agent composition comprising a peroxy compound and the transition metal complex of claim 5 present in an amount effective for the activation of said peroxy compound.

11. The bleaching agent composition of claim 9, wherein said peroxy compound is chosen from the group consisting of hydrogen peroxide; a source of hydrogen peroxide; a peroxycarboxylic acid having 2 to 18 C atoms; a combination of a source of hydrogen peroxide and a peroxycarboxylic acid precursor; and from mixtures thereof.

12. The bleaching agent composition of claim 11, wherein said peroxy compound is an alkali metal perborate monohydrate tetrahydrate or alkali metal percarbonate.

13. The bleaching agent composition of claim 1 1, wherein said peroxy compound is an O-acyl or N-acyl compound.

14. The bleaching agent composition of claim 10, wherein said peroxy compound is chosen from the group consisting of hydrogen peroxide; a source of hydrogen peroxide; a peroxycarboxylic acid having 2 to 18 C atoms; a combination of a source of hydrogen peroxide and a peroxycarboxylic acid precursor; and from mixtures thereof.

15. The bleaching agent composition of claim 14, wherein said peroxy compound is an alkali metal perborate monohydrate tetrahydrate or alkali metal percarbonate.

16. The bleaching agent composition of claim 14, wherein said peroxy compound is an O-acyl or N-acyl compound.

17. The bleaching agent composition of claim 9, further comprising one or more surfactants.

18. The bleaching agent composition of claim 10, further comprising one or more surfactants.

19. The bleaching agent composition of claim 17, further comprising zeolites.

20. The bleaching agent composition of claim 18, further comprising zeolites.

21. The bleaching agent composition according to claim 9, wherein said transition metal complex comprises 0.0001 to 50 wt. % of said bleaching agent composition based on the content of peroxy compound or precursor thereof.

22. The bleaching agent composition of claim 21, wherein said transition metal complex comprises 0.01 to 20 wt. % of said bleaching agent composition based on the content of peroxy compound or precursor thereof.

23. The bleaching agent composition according to claim 10, wherein said transition metal complex comprises 0.0001 to 50 wt. % of said bleaching agent composition based on the content of peroxy compound or precursor thereof.

24. The bleaching agent composition of claim 23, wherein said transition metal complex comprises 0.01 to 20 wt. % of said bleaching agent composition based on the content of peroxy compound or precursor thereof.

25. A method of bleaching a textile comprising contacting said textile with an aqueous solution containing the bleaching agent composition of claim 9 for a time and under conditions sufficient to accomplish said bleaching.

26. The method of claim 25, wherein said method is carried out at a temperature of less than 60° C.

27. A method of bleaching a textile comprising contacting said textile with an aqueous solution containing the bleaching agent composition of claim 10 for a time and under conditions sufficient to accomplish said bleaching.

28. The method of claim 27, wherein said method is carried out at a temperature of less than 60° C.
